(19) United States
(12) Patent Application Publication
(10) Pub. No.: US 2003/0119473 A1
(43) Pub. Date: Jun. 26, 2003

(54) Adjustable balanced modulator

(76) Inventors: Stephen H. Smith, Leucadia, CA (US); Jimmie R. Asbury, San Diego, CA (US)

Correspondence Address: KENYON & KENYON, 1500 K STREET, N.W., SUITE 700, WASHINGTON, DC, 20005, US

(21) Appl. No.: 10/366,378

(22) Filed: Feb. 14, 2003

Related U.S. Application Data
(62) Division of application No. 09/436,236, filed on Nov. 9, 1999.
(60) Provisional application No. 60/150,703, filed on Nov. 9, 1998.

(51) Int. Cl. H04B 1/26

(52) U.S. Cl. 455/326

(57) ABSTRACT

An adjustable balanced modulator includes first and second non-linear devices. The first non-linear device receives an RF input signal and an in-phase LO signal to produce a first mixed signal. The second non-linear device receives the RF input signal and the out-of-phase LO signal to produce a second mixed signal. A summer sums the two mixed signals to produce an output signal including sum and difference product terms and a suppressed RF input term. The performance of the balanced modulator is improved by using an adjustable phase corrector and/or adjustable bias voltages. An adjustable phase corrector can be used to adjust the RF input signals to the non-linear devices to be substantially in-phase to more effectively suppress the original RF input signal in the output signal. Bias voltages can be used to bias the non-linear devices to operate in a linear range and to equalize the levels of the sum and difference product terms.

### CROSS-REFERENCE TO RELATED APPLICATIONS

This application is a division of U.S. application Ser. No. 09/436,236, filed Nov. 9, 1999, now pending, which is a continuation of U.S. Provisional Application No. 60/150,703, filed Nov. 9, 1998.

This application is related to the subject matter of U.S. application Ser. No. 09/064,525, filed Apr. 23, 1998, now U.S. Pat. No. 6,271,790, which is incorporated by reference herein.

This application is related to the subject matter of the following U.S. applications, all filed on Nov. 9, 1999: U.S. application Ser. No. 09/436,531, now U.S. Pat. No. 6,295,025, U.S. application Ser. No. 09/437,892, now U.S. Pat. No. 6,340,950, U.S. application Ser. No. 09/436,400, now pending, U.S. application Ser. No. 09/436,763, now U.S. Pat. No. 6,393,265, and U.S. application Ser. No. 09/436,144, now U.S. Pat. No. 6,317,097.

### BACKGROUND OF THE INVENTION

The present invention relates to the field of communications, and more particularly to balanced modulators.

Modulation, in the context of communications, can be described as the process of encoding source data onto a carrier frequency. Mixers can be used for modulators to translate a baseband signal to an RF frequency band, and mixers can be used as product detectors to translate RF signals to baseband in a demodulator. A mixer performs a multiplication function on the two signals, the band limited RF input signal Vᵢₙ(t) and a local oscillator V_{LO}(t). Mixers are typically classified as being unbalanced, single balanced or double balanced. In the general case, the output of a mixer includes: Vₒᵤₜ=A Vᵢₙ(t)+B V_{LO}(t)+C Vᵢₙ(t)V_{LO}(t)+other terms, where A, B and C are constants. Where A and B are not zero, the mixer is said to be unbalanced because Vᵢₙ(t) and V_{LO}(t) (the input signals) feed through to the output. A single balanced mixer (ideally) has feedthrough for only one of the inputs. A double balanced mixer (ideally) has feedthrough from neither of the input signals.

Currently available balanced mixers and modulators, however, suppress the input signals only approximately 20-25 dB with respect to the output signal, leaving a portion of the input signals to bleed through. While such a reduction in the input signals is sufficient for many applications, some applications require even greater suppression of the input signals in the output signal.

Therefore, a need exists for an improved balanced mixer or modulator that improves the suppression of one or more of the input signals.

### SUMMARY OF THE INVENTION

The adjustable balanced modulator of the present invention overcomes the disadvantages and drawbacks of known modulators by providing both a unique structure of the modulator and by providing several ways to adjust the modulator to improve its performance. The adjustable balanced modulator modulates two input signals, including a local oscillator signal, and an RF input signal. The RF input signal can be a band limited signal centered at (or modulated onto) a carrier frequency f_{C}.

A phase inverter receives a local oscillator (LO) signal at a frequency f_{LO} and produces a first (in-phase) LO signal and a second (out-of-phase) LO signal. The adjustable balanced modulator also includes first and second non-linear devices. The first non-linear device receives the RF input signal (e.g., centered at a frequency f_{C}) and the in-phase LO signal (at a frequency f_{LO}) to produce a first mixed signal. The second non-linear device receives the RF input signal and the out-of-phase LO signal to produce a second mixed signal. A summer sums the two mixed signals to produce an output signal including two intermodulation products (product terms, including a sum term and a difference term).

The performance of the balanced modulator is improved by using an adjustable phase corrector and/or adjustable bias voltages. An adjustable phase corrector can be used to maintain the RF input signals substantially in-phase to provide greater suppression of one of the input signals (e.g., the LO signal and/or the RF input signal). Bias voltages are used to bias the non-linear devices to operate in a substantially linear region (e.g., to prevent unwanted harmonics in the output signal) and can be used to equalize the levels of the sum and difference product terms output from the modulator. In this manner, modulator performance is significantly improved.

### BRIEF DESCRIPTION OF THE DRAWINGS

FIG. 1 is a block diagram of an adjustable balanced modulator according to an embodiment of the present invention.

FIG. 2 is a diagram illustrating a spectral content of an output signal of an adjustable balanced modulator according to an embodiment of the present invention.

FIG. 3 is a flow chart illustrating operation of an adjustable balanced modulator according to an embodiment of the present invention.

FIG. 4 is a block diagram illustrating an adjustable balanced modulator according to another embodiment of the present invention.

FIG. 5 is a schematic diagram illustrating an adjustable balanced modulator according to yet another embodiment of the present invention.

FIG. 6 is a block diagram illustrating a transmitter system according to an embodiment of the present invention.

### DETAILED DESCRIPTION

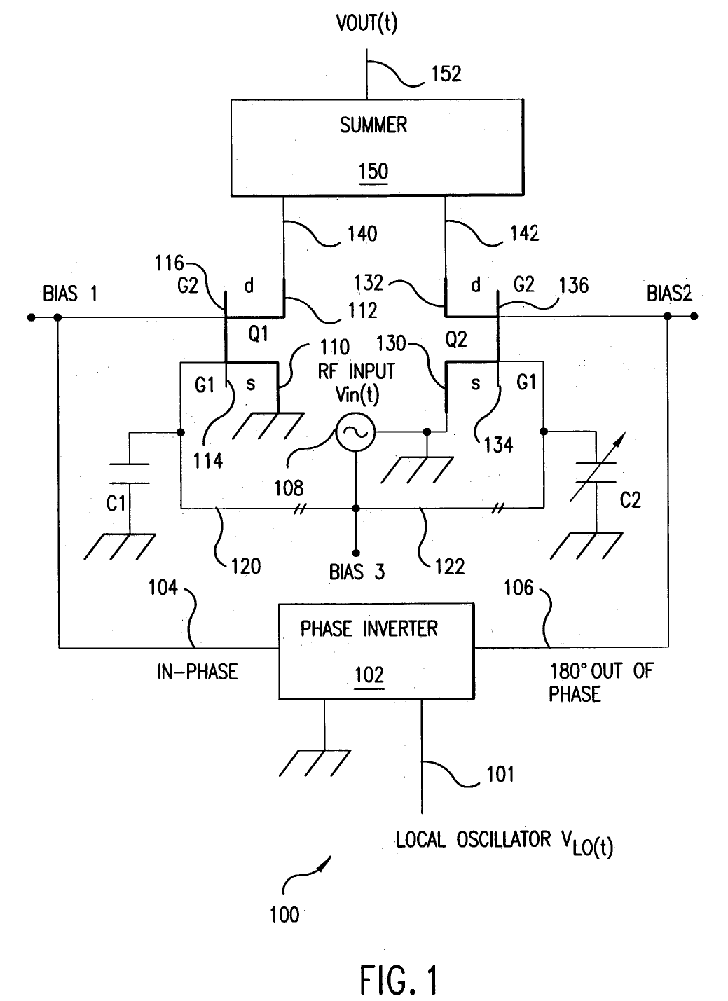

Referring to the drawings in detail, wherein like numerals indicate like elements, FIG. 1 is a block diagram of the adjustable balanced modulator according to an embodiment of the present invention. An adjustable modulator 100 operates to generate a modulated output Vout(t) signal based on two input signals: an RF input signal and a local oscillator. Modulator 100 includes a phase inverter 102 for generating a phase shifted signal, first and second non-linear devices each receiving two input signals and outputting a mixed signal, a phase corrector for equalizing phases of a signal and a summer 150 for summing the two signals output from the first and second non-linear devices.

Modulator 100 receives two input signals. An RF input source 108 provides a band-limited RF input signal, which may be centered around a carrier frequency f_{c}. For example, the RF input signal may be an information signal modulated onto a carrier f_{C}. The second input signal is a local oscillator (LO) signal V_{LO}(t).

Modulator 100 includes a phase inverter 102 which receives a first local oscillator (LO) signal (at a frequency f_{LO}) via line 101 and outputs the first LO signal on line 104 and (a second LO signal) a phase shifted version of the first LO signal, also at a frequency of f_{LO} on line 106. The phase shifted LO signal on line 106 is approximately 180 degrees out of phase from the LO signal on line 104. Phase inverter 102 can be, for example, a transformer, an operational amplifier (op amp), a transistor, or the like.

Balanced modulator 100 includes first and second non-linear devices. According to an embodiment of the present invention, the first and second non-linear devices are implemented as a first transistor Q1 and a second transistor Q2, respectively. Transistors Q1 and Q2 can be, for example, field effect transistors (FETs). According to the embodiment illustrated in FIG. 1, the transistors Q1 and Q2 are double-gate FETs. Other types of non-linear devices can be used, such as operational amplifiers, differential transistors, etc. The non-linear devices can advantageously include some degree of adjustability to allow performance of the balanced modulator to be fine-tuned or adjusted, as described below.

First transistor Q1 includes a source terminal (s) 110, a drain terminal (d) 112, a first gate terminal (G1) 114 and a second gate terminal (G2) 116. Source terminal 110 is connected to ground. Second gate terminal 116 receives the in-phase LO signal via line 104. A first bias voltage (Bias1) is also coupled to the second gate terminal 116 to bias the first transistor Q1 to operate in a substantially linear operating region. The RF input signal (e.g., centered at a carrier frequency f_{C}) is output onto two paths, including lines 120 and 122. The RF input signal is coupled to the first gate terminal 114 via line 120. A first capacitor C1 is connected between line 120 and ground.

Second transistor Q2 includes a source terminal (s) 130, a drain terminal (d) 132, a first gate terminal (G1) 134 and a second gate terminal (G2) 136. Source terminal 130 is connected to ground. Second gate terminal 136 receives the out-of-phase LO signal via line 106. A second bias voltage (Bias2) is also coupled to the second gate terminal 136 to bias the second transistor Q2 to operate in a substantially linear operating region. The RF input signal is coupled to the first gate terminal 134 via line 122. A second capacitor C2 is connected between line 122 and ground.

A third common bias voltage (Bias3) is connected in common via lines 120 and 122 to the first gate terminals (G1) 114 and 134 of Q1 and Q2, respectively. Bias3 can be a negative voltage for further placing transistors Q1 and Q2 in an optimal linear operating region.

The lengths of lines 120 and 122 can be approximately the same length to keep the RF input signals on both lines 120 and 122 in-phase (as indicated by the double hash marks on lines 120 and 122). Because it is difficult for lines 120 and 122 to be exactly the same length, however, the two RF input signals input to the transistors Q1 and Q2 will typically be slightly out of phase. When the phases of the input signals are different (out-of-phase), this limits or decreases the suppression of the original RF input signal in the output of the balanced modulator 100. Therefore, to better suppress one of the input signals (in this case, the RF input signal), the present invention advantageously provides an adjustable phase corrector for correcting or equalizing the phases of the RF input signals on lines 120 and 122. Different types of phase correctors (or phase adjusters) can be used. According to the embodiment of the present invention illustrated in FIG. 1, the phase corrector includes first and second capacitors C1 and C2. One or both of capacitors C1 and C2 are adjustable to fine tune and equalize the phases of the signals in lines 120 and 122. In FIG. 1, capacitor C2 is shown as being adjustable, although, C1 may also be adjustable. According to an embodiment of the present invention illustrated in FIG. 1, C1 (the fixed capacitor) can be chosen to be 1 to 2 pf, and C1 can be ½ of the range of C2 (the variable capacitor). More generally, the fixed capacitor can be ½ the maximum value of the variable capacitor.

Transistor Q1 produces a first mixed output signal onto line 140 that includes one or more input signals, including the RF input signal Vᵢₙ(t) and the in-phase local oscillator signal V_{LO}(t) which can be fed through, and a sum term, [Vᵢₙ(t) (centered at carrier frequency f_{C})+V_{LO}(t) (at frequency f_{LO})]. The sum term results from the fact that the LO is in phase with the RF input, causing the two signals to be added together. However, because transistor Q1 preferably operates in the linear region, the first mixed output signal likely will not include any additional harmonics, such as second harmonics (2f_{C}+f_{LO}), third harmonics, fourth harmonics, etc. Q1 outputs a signal on line 140 including the sum term at a frequency f_{C}+f_{LO}, the RF input signal at a frequency of f_{C} and the LO signal at a frequency of f_{LO}.

Likewise transistor Q2 produces a second mixed output signal onto line 142 that includes one or more input signals, including the RF input signal Vᵢₙ(t) and the out-of-phase local oscillator signal V_{LO}(t) which can be fed through, and a difference term [Vᵢₙ(t)−V_{LO}(t)]. The difference term is caused by the LO signal being 180 degrees out of phase creating a subtraction of the LO signal. Because transistor Q2 preferably operates in the linear region, the second mixed output signal likely will not include any additional harmonics. Q2 outputs a signal on line 142 including the difference term at a frequency of f_{C}−f_{LO}, the RF input signal at a frequency f_{C} and the LO signal at a frequency of f_{LO}.

A summer 150 receives the first mixed signal via line 140 and the second mixed signal via line 142, and sums these two signals to produce an output signal provided on line 152. Summer 150 can be, for example, a differential summer, a differential amplifier or a transformer where the inputs are added 180 degrees out of phase. Both Q1 and Q2 outputs an RF input term at a frequency of f_{C}. These RF input terms output by Q1 and Q2 will be in-phase if the phase corrector is properly adjusted. Summer 150 then adds these two input signals, 180 degrees out of phase, effectively subtracting the two RF input signals. As a result, the output on line 152 includes at least the sum and difference product terms, with the RF input signal suppressed (due to cancellation of the 2 RF input terms) if the phase corrector is properly adjusted. By properly adjusting the phase corrector, the RF input signal can be suppressed 40 dB or more as compared to the product terms.

In addition, the output signal can also include the local oscillator (LO) signal, or the modulator 100 can suppress the LO signal. Therefore, the adjustable balanced modulator 100 can be either a single balanced modulator or a double balanced modulator. If the frequency response of summer 150 is outside of the LO frequency, then summer 150 will inherently suppress the LO signal as well. Alternatively, a bandpass filter can be connected to the output 152 of modulator 100 to filter out or remove the LO signal from the output signal. Moreover, according to an embodiment of the present invention, even if the LO signal is not suppressed by summer 150 or is not removed using a bandpass filter, many antenna systems will not transmit a signal less than, for example, 600 MHz. Thus, if a LO signal is outside the frequency response of the antenna system, such an LO signal will not be transmitted (e.g., LO signal is effectively suppressed by the antenna).

According to an embodiment of the present invention, two adjustable balanced modulators 100 can be combined in parallel to form an adjustable double balanced modulator to also suppress the LO signal. In such case, the outputs of both the modulators 100 would be input into an additional summer (e.g., transformer) to generate the output signal of the double balanced modulator, where the double balanced modulator output includes only product terms, while suppressing the RF input signal and the LO signal.

It should be understood that in the general case, the inputs illustrated in FIG. 1 may be switched. That is, the RF input signal (modulated onto the carrier signal) may be input to the phase inverter 102, and source 108 would be a local oscillator (LO) source. In such a case, adjustment of phase corrector (e.g., capacitor C2) would operate to improve suppression of the LO signal in the output signal.

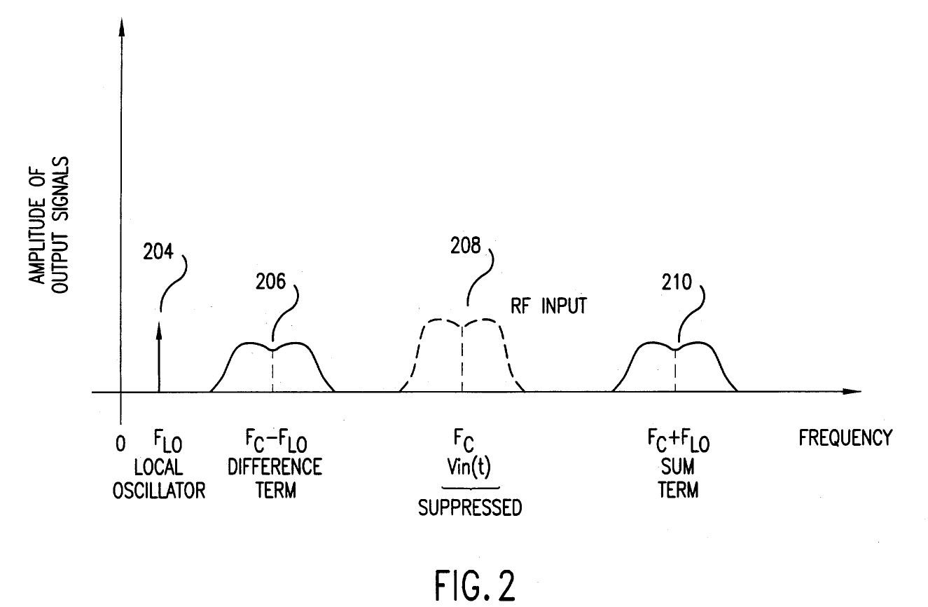

FIG. 2 is a diagram illustrating the spectral content of the output signal of the balanced modulator 100 according to an embodiment of the present invention. The output signal on line 152 includes two product terms, including a sum term 210 located at a frequency f_{C}+f_{LO}, and a difference term 206 located at a frequency f_{C}−f_{LO}, where f_{C}is the carrier frequency of the original RF input signal Vᵢₙ(t) and f_{LO} is the frequency of the local oscillator. As noted above, the output signal may also include the original LO signal 204 at f_{LO} (or, the LO may be suppressed). A dashed line in FIG. 2 indicates that the RF input signal 208 is suppressed by modulator 100 (particularly, when the phase corrector C2 is properly adjusted). As understood by those skilled in the art, it is not necessary for f_{C} to be greater than f_{LO}. Rather, f_{LO} can be greater than f_{C}.

The adjustable bias voltages, Bias1 and Bias2, bias the transistors by adjusting the drain currents of transistors Q1 and Q2, respectively, to operate in a linear region. Moreover, the bias voltages can be further adjusted (preferably within the linear operating range of transistors Q1 and Q2) to set the amplitudes or levels of sum term 210 and the difference term 206 of the output signal (FIG. 2) to predetermined levels. Bias1 affects the amplitude of one of the terms (sum or difference terms), while Bias2 affects the amplitude of the other term. For example, according to the embodiment illustrated in FIGS. 1 and 2, Bias1 affects the amplitude of the sum term, while Bias2 affects the amplitude of the difference term. In certain applications, it may be desirable to make the amplitudes of the sum and difference terms different. However, in other applications, the best performance of balanced modulator 100 occurs when the RF input (at the carrier frequency) is fully suppressed and the levels or amplitudes of the sum and difference terms are equalized. Thus, for best performance (highest gain) in these applications, the phases of the RF input signals input to Q1 and Q2 should be balanced or equalized (e.g., by adjusting the phase corrector, C1 and/or C2) and the levels of the sum and difference terms 210 and 206, respectively (FIG. 2), of the output signal should be matched or equalized (e.g., by properly adjusting the values of the bias voltages, Bias1 and Bias2). Thus, the balanced modulator 100 of the present invention allows the adjustment of the RF input signal phases to improve RF input (and carrier) suppression and allows adjustment of the non-linear devices (e.g., by adjusting the bias voltages of the transistors) to equalize the levels of the output product terms, and thereby improve significantly upon the performance of existing mixers or modulators.

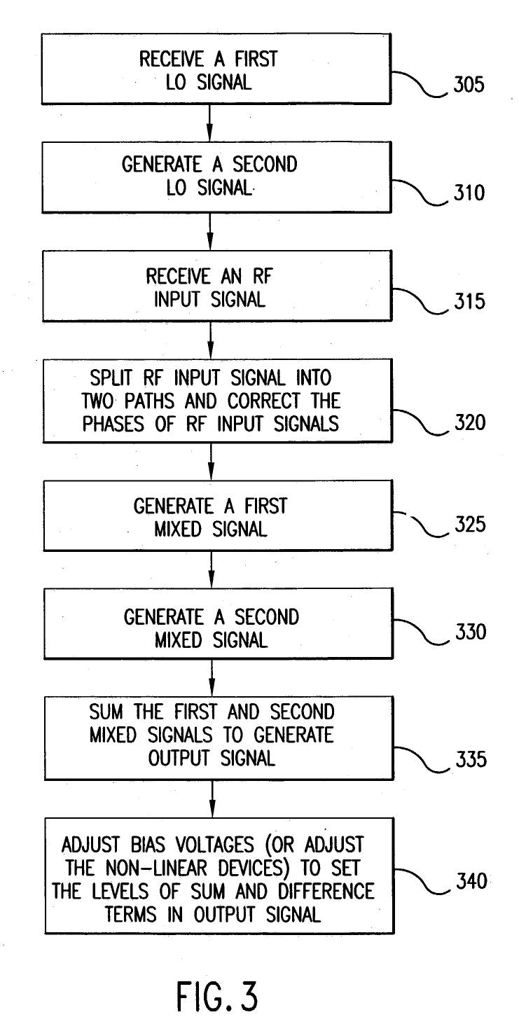

FIG. 3 is a flow chart illustrating the operation of the adjustable balanced modulator of the present invention. Referring to FIGS. 1 and 3, at step 305, a first LO signal is received. At step 310, a second LO signal is generated that is 180 degrees out of phase with the first LO signal. At step 315, an RF input signal is received. At step 320, the RF input signal is split into two paths (e.g., lines 120 and 122, FIG. 1). The phases of the RF input signals on the two paths are corrected or adjusted to be in-phase. At step 325, a first mixed signal is generated by, for example, pumping a first non-linear device using the in-phase local oscillator signal and the phase corrected RF input signal. At step 330, a second mixed signal is generated by, for example, pumping a second non-linear device using the out-of-phase local oscillator signal and the phase corrected RF input signal. At step 335, the first and second mixed signals are summed to generate an output signal including sum and difference terms and having a substantially suppressed RF input signal. At step 340, the non-linear devices are adjusted or biased to set the levels of the output product terms (sum and difference terms) to predetermined levels. According to an embodiment of the present invention, the bias voltages are adjusted to equalize the levels of the sum and difference terms.

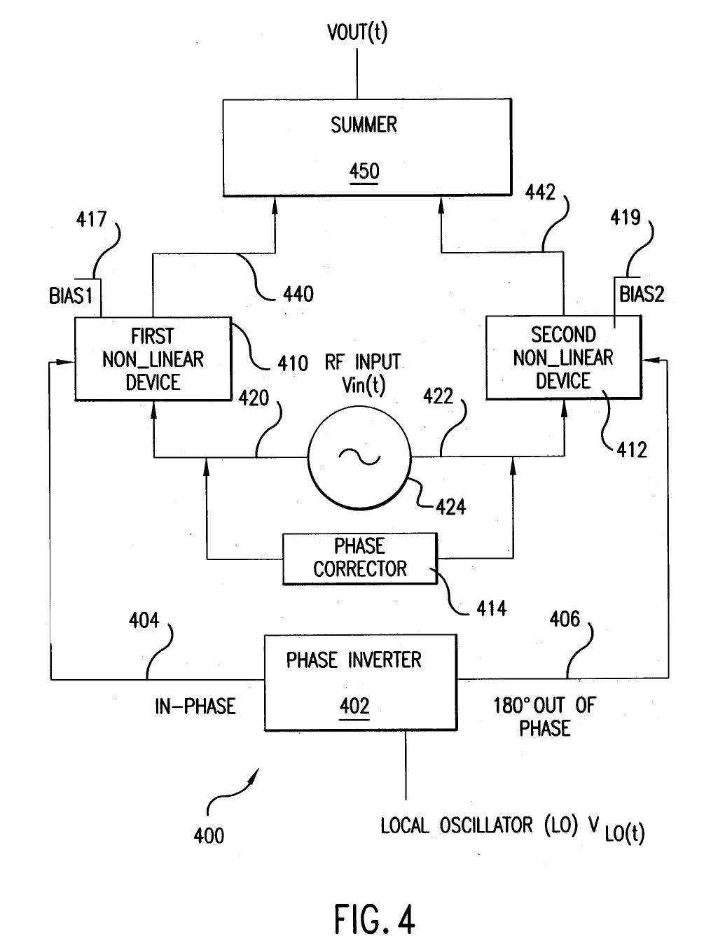

FIG. 4 is a block diagram illustrating an adjustable balanced modulator 400 according to another embodiment of the present invention. The embodiment of FIG. 4 is similar to that in FIG. 1, but is more general than FIG. 1. Briefly, a phase inverter 402 receives a local oscillator signal and produces a first (in-phase) local oscillator (LO) signal on line 404 and a second local oscillator (LO) signal on line 406 that is 180 degrees out of phase with the first LO signal. An RF input source 424 supplies an RF input signal on lines 420 and 422.

The adjustable balanced modulator 400 includes a first non-linear device 410 and a second non-linear device 412. A phase corrector 414 can be used to adjust or correct the RF input signals on lines 420 and 422 to be substantially in-phase. First non-linear device 410 is pumped by the in-phase LO signal via line 404 and the phase corrected RF input signal via line 420 and produces a first mixed signal on line 440. Second non-linear device 412 is pumped by the out-of-phase LO signal received via line 406 and the phase corrected RF input signal received via line 422 and produces a second mixed signal on line 442.

A summer 450 sums the first and second mixed signals received via lines 440 and 442 to produce an output signal including product terms and where the RF input signal is suppressed. Use of the phase corrector 414 to equalize the phases of the RF input signals greatly improves the suppression of the RF input signal.

The first non-linear device 410 is adjusted or biased by a first bias voltage (Bias1 ) supplied via line 417 to operate in a substantially linear region, and the second non-linear device 412 is adjusted or biased by a second bias voltage (Bias2) supplied via line 419 to operate in a substantially linear region. In addition, Bias1 and Bias2 can be further adjusted to set the levels or amplitudes of the sum and difference terms in the output signal to predetermined levels. According to an embodiment of the present invention, for applications that require equal amplitudes of the sum and difference terms, the bias voltages can be used to substantially equalize the levels of the sum and difference terms to improve performance of modulator 400.

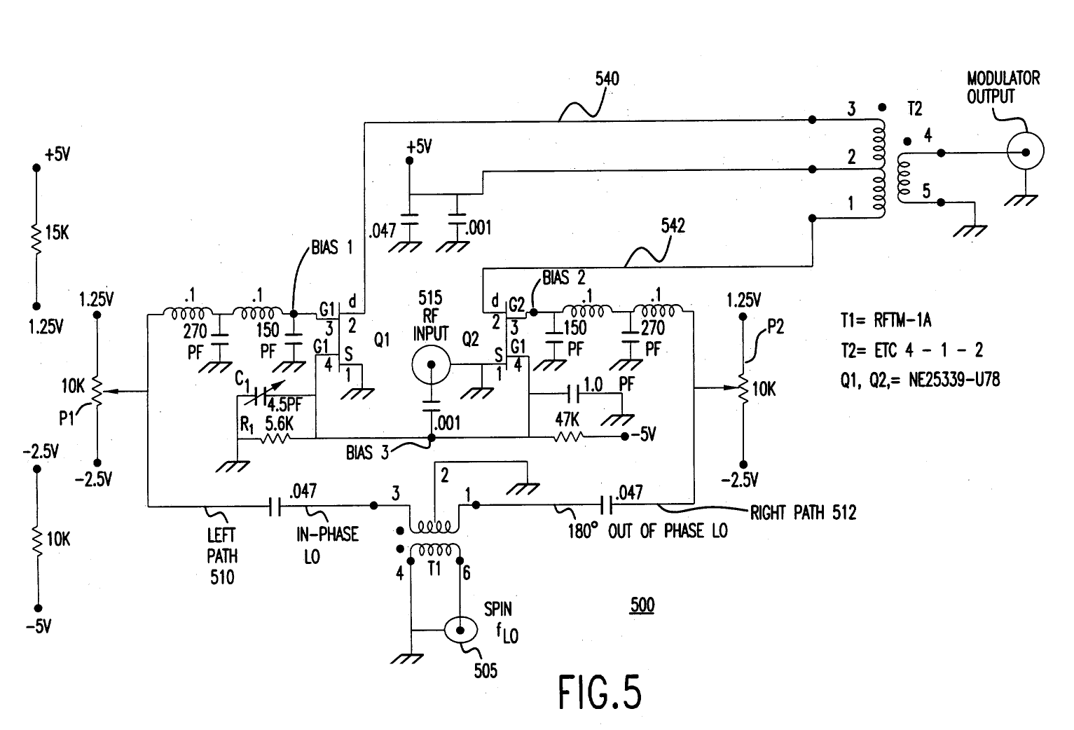

FIG. 5 is a schematic diagram of an adjustable balanced modulator 500 according to another embodiment of the present invention. A local oscillator source 505 provides a local oscillator signal to a transformer T1. Transformer T1 operates as a phase inverter to generate an in-phase version of the LO signal (indicated by the dot) on the left path 510, and a 180 degree out-of phase version of the LO signal on the right path 512. An RF input source 515 provides an RF input signal. As an example, the RF input signal can be an input signal that is amplitude modulated (double-sideband-suppressed carrier modulation) onto a carrier frequency of 800 MHz, while the local oscillator (LO) signal can be provided at 40 MHz. Other frequencies, however, can be used.

Transistors Q1 and Q2 operate as non-linear devices (but are biased to operate in the substantially linear region). A first adjustable bias voltage (Bias1 ) is provided to the second gate terminal (G2) of Q1. Bias1 can be adjusted (to set the operating point of Q1 and to set the levels of a corresponding output product term) by using a first potentiometer P1, which is connected between 1.25V and −2.5 V. Alternative upper and lower voltages of 5V and 1.25V, and −2.5V and −5V are shown for P1. Similarly, a second potentiometer P2 is used to provide a second adjustable bias voltage Bias2 to the second gate terminal (G2) of Q2, and includes the same alternative upper and lower voltages as P1. Bias2 sets the operating point of Q2 and also sets the level or amplitude of a corresponding output product term. A third bias voltage (Bias3) is connected in common to the first gate terminals (G1) of Q1 and Q2 to further set the operating point of Q1 and Q2 in the linear region.

Adjustable capacitor C1 is connected to the first gate G1 of transistor Q1 and operates as a phase corrector by allowing the phase of the RF input signal input to Q1 be adjusted to be substantially in-phase with the RF input signal input to Q2.

Transistor Q1 generates a first mixed signal via line 540. Transistor Q2 produces a second mixed signal via line 542. A second transformer T2 operates as a differential summer to sum the two mixed signals received via lines 540 and 542, and outputs a signal having sum and difference terms with substantially matching amplitudes or levels (based on the adjustment of the bias voltages), and a substantially suppressed RF input signal based on the balancing of the phases of the RF input signals using the phase corrector (C1).

According to an embodiment of the present invention, transformer T1 can be a transformer part number RFTM-1A available from RF Prime Co., and transformer T2 can be a 4:1 transformer part number ETC 4-1-2 from MA/COM, Inc. Other transformers can be used as well.

According to an embodiment of the present invention, the adjustable balanced modulator of the present invention can be used in a communications system to modulate an information signal and rotational frequency signal as described in detail in issued U.S. Pat. No. 6,271,790 (the “'790 patent”). For purposes of clarity, note that the intermodulation products described above are referred to generically as “sidebands” in the '790 patent.

As described in detail in the '790 patent, a communications channel is defined at least in part by an electromagnetic wave having a carrier frequency and an electric (E) field vector. The extremity or terminus of the E field vector traces a non-linear periodic path at a rotation frequency less that the carrier frequency and greater than zero from the perspective of an observer looking into the axis of propagation of the wave. The combination of the rotation frequency (defining a particular periodic path of the terminus of the E field vector) and the carrier frequency define a communications channel.

The information signal is modulated onto a carrier frequency. Any suitable rotation frequency can be selected that is greater than one-half of the bandwidth of the information signal and less than the carrier frequency. For example, according to an embodiment of the present invention, a rotation frequency can be chosen that is 1/30th of the carrier frequency.

The adjustable balanced modulator of the present invention (e.g., modulator 100, 400 or 500) can be used to modulate the modulated information signal and the rotation frequency signal. In such a case, in FIG. 1, the local oscillator (LO) signal is replaced in FIG. 1 by the rotation frequency signal, and the RF input signal is replaced by the modulated information signal. The balanced modulator 100 then outputs a signal including substantially balanced sum and difference terms (based on the adjustment of the bias voltages of the non-linear devices), while the original modulated information signal (including carrier signal) is substantially suppressed (based on the adjustment of the phase corrector.)

For example, the modulator of the present invention (e.g., modulator 100, 400 or 500) can be used by the system of the '790 patent in place of the balanced mixer modulator 104 (FIG. 2), and/or in place of voltage variable attenuator 142 (FIG. 5), and/or as a component within nonlinear periodic path modulator 506 (FIG. 15) and/or as a component within the nonlinear periodic path demodulator 518 (FIG. 15).

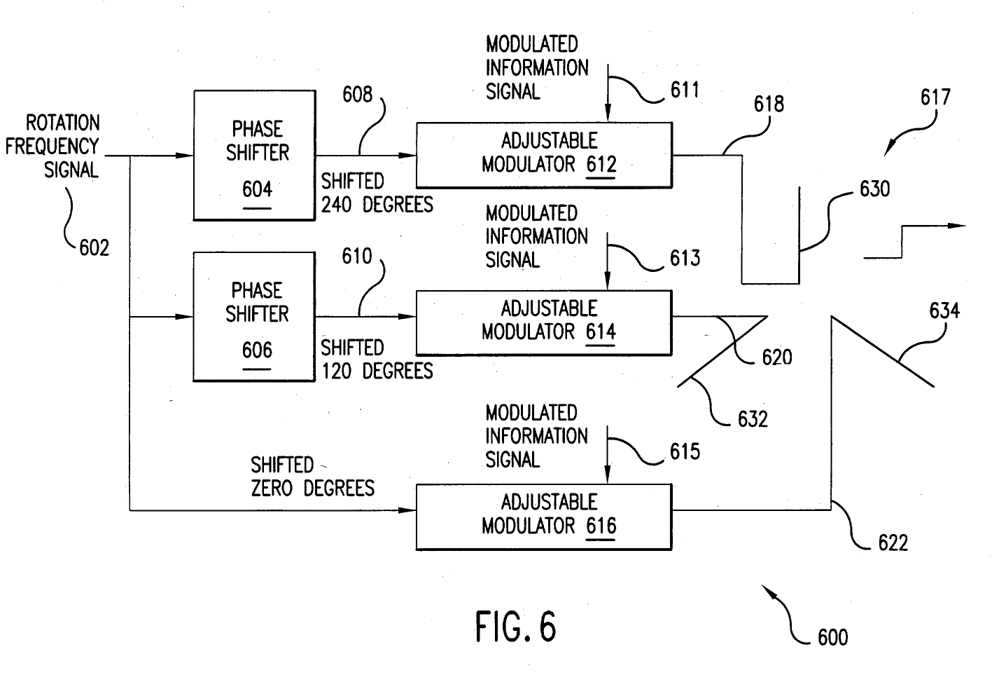

FIG. 6 is a block diagram of a transmitter system 600 according to an embodiment of the present invention. A rotation frequency signal is received via line 602. Three different phase shifted versions of the rotation frequency signal are required according to this embodiment of the present invention. The rotation frequency signal is input to phase shifters 604 and 606. Phase shifter 606 shifts the rotation frequency signal by 120 degrees to generate a 120 degree phase shifted rotation frequency signal onto line 610. Phase shifter 604 shifts the rotation frequency signal 240 degrees to output a 240 degree phase shifted rotation frequency signal onto line 608.

Transmitter system 600 also includes three adjustable balanced modulators 612, 614 and 616, each of which may be the same as modulators 100, 400 or 500 according to embodiments of the present invention. Modulator 616 modulates the unshifted rotation frequency signal received via line 602 and a modulated information signal received via line 615, and outputs a signal on line 622. Although not shown in FIG. 6, an information signal is modulated (e.g., amplitude, frequency or phase modulated) onto a carrier frequency signal to generate the modulated information signal that is provided on lines 611, 613 and 615 which are input to modulators 612, 614 and 616.

Modulator 614 modulates the 120 degree shifted rotation frequency signal received via line 610 and the modulated information signal received via line 613, and outputs a signal on line 620. Modulator 612 modulates the 240 degree shifted rotation frequency signal received via line 608 and the modulated information signal received via line 611, and outputs a signal on line 618.

Modulators 612, 614 and 616 are coupled via lines 618, 620 and 622 to an antenna system 617 including antenna elements 630, 632 and 634, respectively. Antenna elements 630, 632 and 634 may be monopoles, dipoles, or other antenna elements.

According to an embodiment of the present invention, the bias voltages and phase correctors of modulators 612, 614 and 616 are properly adjusted so that each modulator outputs a signal that includes substantially equalized sum and difference intermodulation product terms and a suppressed modulated information signal (including a suppressed carrier frequency signal). The output signals are then output to antenna elements 630, 632 and 634. Each antenna element 630, 632 and 634 radiates an individual electromagnetic (EM) wave. The individual EM waves radiated or transmitted from each antenna element 630, 632 and 634 superpose to create a resultant EM wave. The terminus of the Electric (E) field vector of the resultant EM wave rotates about the axis of propagation at a rate equal to the rotation frequency signal. (Note that the resultant EM wave “rotates” about the axis of propagation in a very specific sense with respect to a rosette pattern, as described in detail in the '790 patent).

The combination of the rotation frequency (defining a particular periodic path of the terminus of the E field vector) and the carrier frequency define a communications channel. One channel system, including a group of two phase shifters 604 and 606 and a group of three modulators 612, 614 and 616 (illustrated in FIG. 6), provide the transmission signals for one channel, where the channel is defined by the frequency of the rotation frequency signal and the carrier frequency of the modulated information signal.

Many additional communication channels can also be transmitted simultaneously over the antenna system 617. Each additional channel is defined by a unique combination of carrier frequency and rotation frequency. A separate channel system including a separate group of two phase shifters and three modulators are provided for each separate channel. Each channel system receives a rotation frequency signal and a modulated information signal (at a carrier frequency), where the combination of rotation frequency and carrier frequency is unique for each channel transmitted over antenna system 617.

According to an embodiment of the present invention, the modulators of each channel system receiving a zero shifted rotation frequency signal (which may be at different rotation frequencies) are coupled to a first common antenna element 634. The modulators of each channel system receiving a 120 degree phase shifted rotation frequency signal are coupled to a second common antenna element 632. The modulators of each channel system receiving a 240 degree phase shifted rotation frequency signal are coupled to a third common antenna element 630. The number of modulators per channel corresponds to the number of antenna elements.

In addition, the adjustable balanced modulator of the present invention can be used in the dual carrier embodiment disclosed in the '790 patent. For example, the adjustable balanced modulator of the present invention can be used as the amplitude modulators 246 and 248 in FIG. 12 of the '790 patent.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A balanced modulator comprising:
a first non-linear device, said first non-linear device receiving a first local oscillator signal biased with a first adjusted bias voltage and receiving an input signal;
a second non-linear device coupled to said first non-linear device, said second non-linear device receiving a second local oscillator signal biased with a second adjusted bias voltage and receiving the input signal; and
a phase corrector coupled to said first non-linear device and said second non-linear device, said phase corrector adjusting a phase of the input signal received by at least one of the first and second non-linear devices.

2. The balanced modulator of claim 1, further comprising:
a summer coupled to said first non-linear device and said second non-linear device, said summer receiving a first mixed signal produced by said first non-linear device and receiving a second mixed signal produced by said second non-linear device, said summer producing an output signal.

3. The balanced modulator of claim 2, wherein the output signal includes two intermodulation products having substantially matching levels, and wherein either the input signal or the local oscillator is substantially suppressed.

4. The balanced modulator of claim 2, wherein:
the output signal includes two intermodulation products having substantially matching levels and wherein at least one of the input signal and the local oscillator are substantially suppressed;
the suppressed signal being suppressed by at least 40 dB from the intermodulation products.

5. The balanced modulator of claim 3, wherein the input signal is substantially suppressed.

6. A balanced modulator comprising:
a first non-linear device receiving a first local oscillator signal and receiving an input signal, the first non-linear device producing a first mixed signal;
a first bias voltage terminal supplying a first bias voltage to the first non-linear device;
a second non-linear device receiving a second local oscillator signal and receiving the input signal, the first local oscillator signal being substantially out of phase with the second local oscillator signal, the second non-linear device producing a second mixed signal;
a second bias voltage terminal supplying a second bias voltage to the second non-linear device;
a phase corrector coupled to the input signal and adapted to correct the phases of the input signals received by the first and second non-linear devices to be substantially in-phase; and
a summer summing the first and second mixed signals to produce an output signal.

7. The modulator of claim 6 and further comprising a phase inverter coupled to the first and second non-linear devices, the phase inverter receiving the first local oscillator signal and producing the second local oscillator signal that is substantially 180 degrees out of phase with the first local oscillator signal.

8. The modulator of claim 6 wherein each of said first and second non-linear devices comprises a transistor.

9. The modulator of claim 8 wherein each transistor comprises a double-gate field effect transistor (FET).

10. The modulator of claim 6 wherein said summer comprises a transformer.

11. The modulator of claim 6 wherein said phase corrector comprises an adjustable capacitor.

12. The modulator of claim 6 wherein said first bias voltage biases the first non-linear device to operate in a substantially linear region, and the second bias voltage biases the second non-linear device to operate in a substantially linear region.

13. The modulator of claim 6 wherein the output signal comprises first and second intermodulation product terms, the first and second bias voltages being set to values that set the amplitudes or levels of the product terms to predetermined levels.

14. The modulator of claim 6 wherein said bias voltages are adjustable.

15. The modulator of claim 6 wherein the output signal comprises a first and second intermodulation product terms, the first and second bias voltages being set to values that substantially equalize the amplitudes or levels of the first and second product terms.

16. The modulator of claim 6 wherein the phase corrector is set to a value that substantially suppresses at least one of the local oscillator and the input signal in the output signal.

17. The modulator of claim 16 wherein the phase corrector is set to optimally suppress the input signal in the output signal.

18. The modulator of claim 6 wherein due to an adjustment of said phase corrector and bias voltages, the output signal includes two intermodulation products having substantially matching levels and wherein the input signal is substantially suppressed in the output signal.

19. An adjustable balanced modulator comprising:
a first non-linear device receiving a first local oscillator signal and receiving an RF input signal, the first non-linear device producing a first mixed signal;
a first bias voltage terminal supplying a first adjustable bias voltage to the first non-linear device;
a second non-linear device receiving a second local oscillator signal and receiving the RF input signal, the first local oscillator signal being substantially out of phase with the second local oscillator signal, the second non-linear device producing a second mixed signal;
a second bias voltage terminal supplying a second adjustable bias voltage to the second non-linear device;
an adjustable phase corrector coupled to the RF input signal and allowing correction so that the phases of the RF input signals received by the first and second non-linear devices are substantially in-phase; and
a summer summing the first and second mixed signals to produce an output signal including two intermodulation product terms and a substantially suppressed RF input term, the first and second bias voltages adjusted to substantially equalize the levels of the product terms in the output signal.

20. A modulator comprising:
a phase inverter receiving a first local oscillator signal and producing a second local oscillator signal that is substantially out of phase with the first local oscillator signal;
a first transistor having source and drain terminals and first and second gate terminals, the first gate terminal of the first transistor being coupled to the phase inverter for receiving a first oscillator signal, the second gate terminal of the first transistor receiving an RF input signal, the first transistor outputting a first mixed signal on the drain of the first transistor;
a first bias voltage terminal supplying a first bias voltage to the first gate of the first transistor;
a second transistor having source and drain terminals and first and second gate terminals, the first gate terminal of the second transistor being coupled to the phase inverter for receiving a second oscillator signal, the second gate terminal of the second transistor receiving the RF input signal, the second transistor outputting a second mixed signal on the drain of the second transistor;
a second bias voltage terminal supplying a second bias voltage to the first gate of the second transistor;
a phase corrector coupled to at least one of the transistors and adapted to correct the phase of at least one of the RF input signals received by the first and second transistors; and
a summer summing the first and second mixed signals to produce an output signal.

21. The modulator of claim 20 wherein said phase corrector is adapted to correct the phases of the RF input signals received by the first and second transistors to be substantially in-phase.

22. The modulator of claim 20 wherein said phase corrector is adapted to adjust the phases of the RF input signals received by the first and second transistors so as to substantially suppress the RF input signal in the output signal.

23. The modulator of claim 20 wherein said output signal comprises two intermodulation product terms, the first and second bias voltages being adjusted to set the levels of the product terms to predetermined levels.

24. The modulator of claim 20 wherein said output signal comprises two intermodulation product terms, the first and second bias voltages being adjusted to set the levels of the product terms to substantially the same level.

25. A method of modulation comprising the steps of:
receiving a first local oscillator signal;
generating a second local oscillator signal, the second local oscillator signal being 180 degrees out of phase with the first local oscillator signal;
receiving an RF input signal;
generating a first mixed signal based on the first local oscillator signal and the RF input signal;
generating a second mixed signal based on the second local oscillator signal and the RF input signal; and
adjusting the relative phases of the RF input signals used to generate the first or second mixed signals to be substantially in-phase.

26. The method of claim 25 wherein said step of generating a first mixed signal comprises the step of pumping a first non-linear device based on the first local oscillator signal and the RF input signal to generate a first mixed signal.

27. The method of claim 26 wherein said step of generating a second mixed signal comprises the step of pumping a second non-linear device based on the second local oscillator signal and the RF input signal to generate a second mixed signal.

28. The method of claim 26 wherein the output signal comprises two intermodulation product terms, said method further comprising the step of biasing the first and second non-linear devices so as to substantially equalize the levels of the product terms.

29. A balanced modulator comprising:
a first non-linear device receiving a first local oscillator signal and receiving an input signal, the first non-linear device producing a first mixed signal;
a first bias voltage terminal supplying a first bias voltage to the first non-linear device;
a second non-linear device receiving a second local oscillator signal and receiving the input signal, the second non-linear device producing a second mixed signal;
a second bias voltage terminal supplying a second bias voltage to the second non-linear device;
a phase corrector coupled to the first and second non-linear devices; and
a summer summing the first and second mixed signals to produce an output signal.

30. The balanced modulator of claim 32 wherein the output signal comprises sum and difference product terms having levels that are substantially equalized due to an adustment of the bias voltages, and wherein the input signal is substantially suppressed in the output signal due to an adjustment of the phase corrector.
